(19) United States
(12) Patent Application Publication
(10) Pub. No.: US 2009/0005126 A1
(43) Pub. Date: Jan. 1, 2009

(54) METHOD FOR CONTROLLING POWER CONSUMPTION AND MOBILE COMMUNICATION DEVICE USING SAME

(75) Inventors: WEN-WU WANG, Shenzhen (CN); SHIH-FANG WONG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., lTD., Tu-Cheng (TW)

(21) Appl. No.: 11/960,715

(22) Filed: Dec. 20, 2007

(30) Foreign Application Priority Data
Jun. 29, 2007 (CN) 200710200970.6

(51) Int. Cl. H04M 1/00

(52) U.S. Cl. 455/574

(57) ABSTRACT

A mobile communication device includes a power source, a measurer, a function group, a calculator, a setting module, and a controller. The power source is used for supplying power to the mobile communication device. The measurer is used for measuring remaining coulomb of the power source. The function group includes a plurality of function modules with corresponding priority levels. The calculator is used for calculating coulomb consumption rate of the function modules. The setting module is used for receiving a desired usage time predetermined by users. The controller is used for powering down the function modules according to the remaining coulomb, the coulomb consumption rate, and the desired usage time. A method for controlling the function modules is also provided.

### BACKGROUND

1. Field of the Invention

The present invention generally relates to mobile communication devices, and more particularly to a mobile communication device and a method for controlling power consumption of the mobile communication device.

2. Description of Related Art

Mobile communication devices, such as mobile phones, personal digital assistants (PDA), notebook computers, and so on, are now widely used in wireless communication. The mobile communication devices also provide additional functions, such as short message service (SMS), global positioning system (GPS) service, game, camera, and so on. However, these additional functions consume much power of the mobile communication devices. The mobile communication device needs to manage these additional functions and control power consumption of these additional functions.

Therefore, improvements for a mobile communication device and a method for controlling power consumption of the mobile communication device are needed in the industry to address the aforementioned deficiency.

### SUMMARY

A mobile communication device includes a power source, a measurer, a function group, a calculator, a setting module, and a controller. The power source is used for supplying power to the mobile communication device. The measurer is used for measuring remaining coulomb of the power source. The function group includes a plurality of function modules with corresponding priority levels. The calculator is used for calculating coulomb consumption rate of the function modules. The setting module is used for receiving a desired usage time predetermined by users. The controller is used for powering down the function modules according to the remaining coulombs, the coulomb consumption rate, and the desired usage time. A method for controlling the function modules is also provided.

Other advantages and novel features of the present invention will become more apparent from the following detailed description of preferred embodiment when taken in conjunction with the accompanying drawings.

### BRIEF DESCRIPTION OF THE DRAWINGS

FIG. 1 is a schematic, block diagram showing a mobile communication device in accordance with an exemplary embodiment, the mobile communication device including a plurality of function modules.

FIG. 2 is a table showing a relationship between the function modules of FIG. 1 and their priority levels.

FIG. 3 is a process flow diagram illustrating a method for controlling function modules in accordance with an exemplary embodiment.

### DETAILED DESCRIPTION OF THE EMBODIMENTS

Reference will now be made to the drawings to describe a preferred embodiment of the present mobile communication device and a preferred embodiment of the present method.

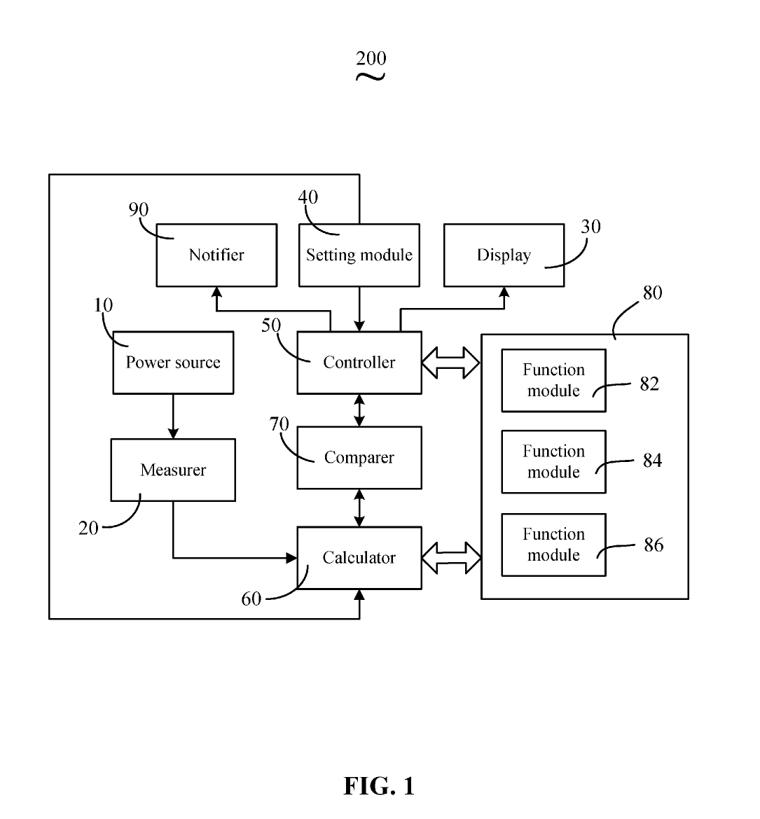

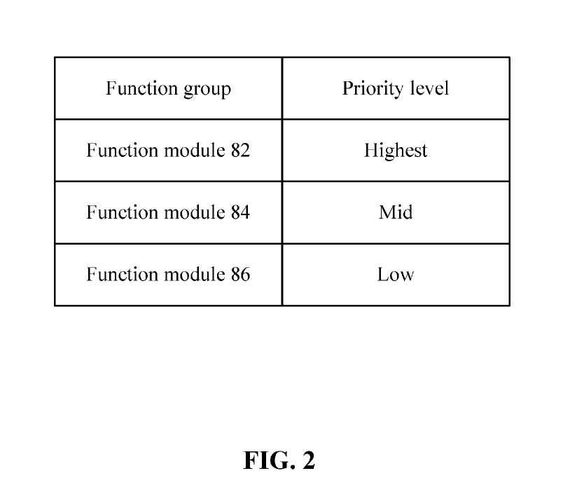

Referring to FIG. 1, a mobile communication device 100 in accordance with an exemplary embodiment is illustrated. The mobile communication device 100 includes a power source 10, a measurer 20, a display 30, a setting module 40, a controller 50, a calculator 60, a comparer 70, a function group 80, and notifier 90. The function group 80 includes a plurality of function modules. In this embodiment, referring to FIG. 2, the function group 80 includes three function modules 82, 84, 86. The function module 82, 84, 86 have corresponding priority levels. For exemplary purposes, the function module 82 is a mandatory function module 82 and has the highest priority level, the function module 84 has a mid priority level, and the function module 86 has a low priority level.

The power source 10 is used for supplying power to other components. The measurer 20 is used for measuring remaining coulombs of the power source 10. The display 30 is used for displaying the remaining coulomb to users. The setting module 40 is used for setting a desired usage time that is predetermined by the users. When the desired usage time is reached, the remaining coulombs should be exhausted. The controller 50 is used for controlling work states of the function modules 82, 84, 86. In detail, the controller 50 can power up or power down the function modules 82, 84, 86.

The calculator 60 is used for calculating a remaining coulomb consumption rate in seconds by dividing the remaining coulombs by the desired usage time in seconds. The calculator 60 is also used for calculating mandatory coulomb consumption rate of the function module 82, and for calculating total consumption rate of the function modules 82, 84, 86. Furthermore, the calculator 60 is used for calculating a longest available time by dividing the remaining coulombs by the mandatory coulomb consumption rate. The notifier 90 is used for indicating the longest available time by some means such as with an image or sound.

The comparer 70 is used for comparing the mandatory coulomb consumption rate with the remaining coulomb consumption rate, and further for comparing the total consumption rate with the remaining coulomb consumption rate when the mandatory coulomb consumption rate is smaller than the remaining coulomb consumption rate.

In operation, the setting module 40 receives the desired usage time predetermined by the users. The measurer 20 measures the remaining coulomb of the power source 10. The calculator 60 calculates the remaining coulomb consumption rate by dividing the remaining coulomb by the desired usage time. The calculator 60 calculates the mandatory coulomb consumption rate of the function module 82. The comparer 70 determines whether the mandatory coulomb consumption rate is larger than the remaining coulomb consumption rate. If the mandatory coulomb consumption rate is larger than the remaining coulomb consumption rate, the calculator 60 calculates the longest operable time by dividing the remaining coulomb by the mandatory coulomb consumption rate. The notifier 90 indicates the longest operable time.

If the mandatory coulomb consumption rate is not larger than the remaining coulomb consumption rate, the comparer 70 determines whether the mandatory coulomb consumption rate is equal to the remaining coulomb consumption rate. If the mandatory coulomb consumption rate is equal to the remaining coulomb consumption rate, the controller 50 powers down the function modules 84, 86.

If the mandatory coulomb consumption rate is smaller than the remaining coulomb consumption rate, the calculator 60 calculates the total coulomb consumption rate of the function module 82, 84, 86. The comparer 70 determines whether the total coulomb consumption rate is larger than the remaining coulomb consumption rate. If the total coulomb consumption rate is not larger than the remaining coulomb consumption rate, the operation is accomplished.

If the total coulomb consumption rate is larger than the remaining coulomb consumption rate, the controller 50 powers down the function module 86 and the calculator 60 calculates a new total coulomb consumption rate of the function module 82, 84. The comparer 70 determines whether the new total coulomb consumption rate is larger than the remaining coulomb consumption rate. If the new total coulomb consumption rate is not larger than the remaining coulomb consumption rate, the operation is accomplished. If the new total coulomb consumption rate is larger than the remaining coulomb consumption rate, the controller 50 powers down the function module 84.

As mentioned above, the mobile communication device 200 powers down its function modules 84, 86 who has lower priority levels according to the remaining coulomb and the desired usage time predetermined by the users in order to provide sufficient power to the function module 82 who has the highest priority level. In another embodiment, the number of the function modules may be N wherein N is a natural number.

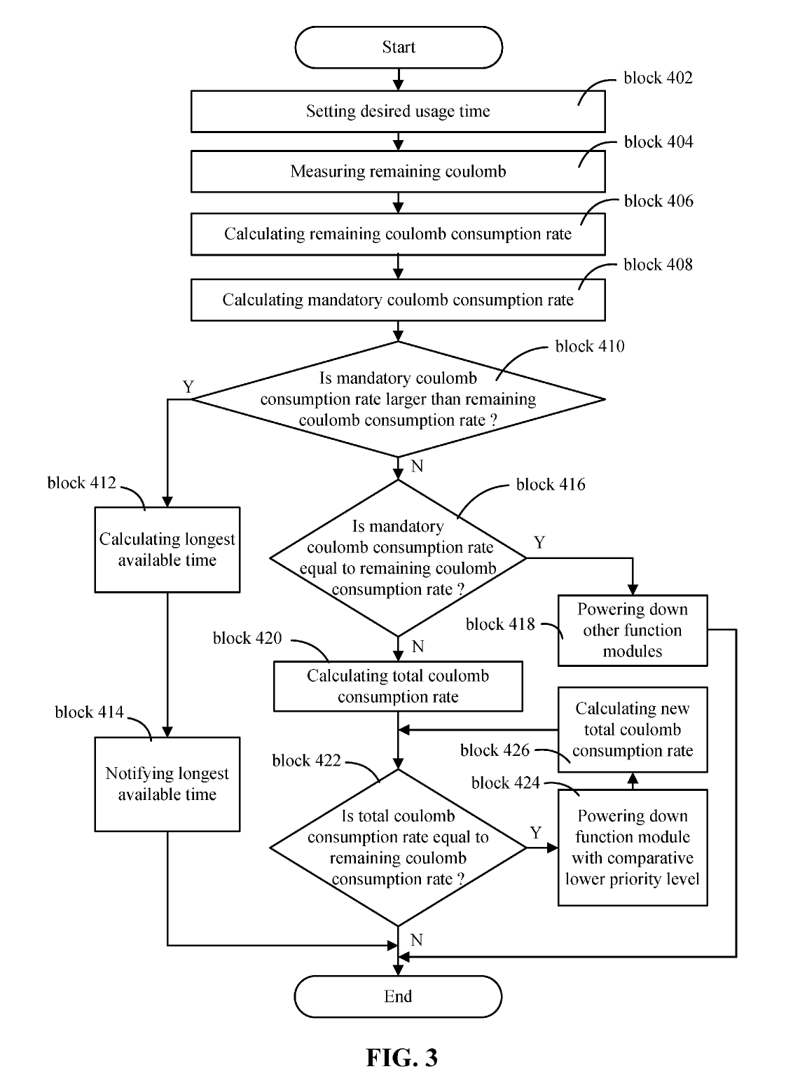

Referring to FIG. 3, a controlling procedure of a method in accordance with an exemplary embodiment is used for controlling power of a mobile communication device. The procedure includes the following blocks.

At block 402, a desired usage time is set by users and received by the mobile communication device.

At block 404, the remaining coulomb of the mobile communication device is measured.

At block 406, a remaining coulomb consumption rate is calculated by dividing the remaining coulomb by the desired usage time.

At block 408, a mandatory coulomb consumption rate of a function module with the highest priority level is calculated.

At block 410, whether the mandatory coulomb consumption rate is larger than the remaining coulomb consumption rate is determined. If the mandatory coulomb consumption rate is larger than the remaining coulomb consumption rate, the procedure goes to block 412. If the mandatory coulomb consumption rate is not larger than the remaining coulomb consumption rate, the procedure goes to block 416.

At block 412, a longest operable time is calculated by dividing the remaining coulomb by the mandatory coulomb consumption rate.

At block 414, the longest operable time is indicated.

At block 416, whether the mandatory unit consumption is equal to the remaining coulomb consumption rate is determined. If the mandatory coulomb consumption rate is equal to the remaining coulomb consumption rate, the procedure goes to block 418. If the mandatory unit coulomb is smaller than the remaining coulomb consumption rate, the procedure goes to block 420.

At block 418, the other function modules except for the function module with the highest priority level are powered down.

At block 420, a total coulomb consumption rate of all the function modules is calculated.

At block 422, whether the total coulomb consumption rate is larger than the remaining coulomb consumption rate is determined. If the total coulomb consumption rate is not larger than the remaining coulomb consumption rate, the procedure is over. If the total coulomb consumption rate is larger than the remaining coulomb consumption rate, the procedure goes to block 424.

At block 424, a function module with a comparative lower priority level is powered down.

At block 426, a new total coulomb consumption rate of the rest function modules except for the powered down function module is calculated, and the procedure goes to block 422.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A mobile communication device comprising:
a power source for supplying power to the mobile communication device;
a measurer for measuring a remaining coulomb of the power source;
a function group comprising a plurality of function modules, each having a priority level;
a calculator for calculating coulomb consumption rate of the function modules;
a setting module for receiving a desired usage time predetermined by users; and
a controller for powering down the function modules according to the remaining coulomb, the coulomb consumption rate, and the desired usage time.

2. The mobile communication device according to claim 1, wherein the calculator is used for calculating a remaining coulomb consumption rate by dividing the remaining coulomb by the desired usage time.

3. The mobile communication device according to claim 2, wherein the calculator is used for calculating a mandatory coulomb consumption rate of the mandatory function module with the highest priority level and a total unit consumption of all the function modules, and is also used for calculating a longest operable time by dividing the remaining coulomb by the mandatory coulomb consumption rate.

4. The mobile communication device according to claim 3, further comprising a comparer for comparing the mandatory coulomb consumption rate with the remaining coulomb consumption rate, and for comparing the total unit consumption with the remaining coulomb consumption rate when the mandatory coulomb consumption rate is smaller than the remaining coulomb consumption rate.

5. The mobile communication device according to claim 4, wherein if the mandatory coulomb consumption rate is equal to the remaining coulomb consumption rate, the controller powers down the other function modules except for the function module with the highest priority level.

6. The mobile communication device according to claim 4, wherein if the total coulomb consumption rate is larger than the remaining coulomb consumption rate, he controller powers down a function module with a comparative lower priority level.

7. The mobile communication device according to claim 3, further comprising a notifier for indicating the longest operable time.

8. The mobile communication device according to claim 1, further comprising a display for displaying the remaining coulomb to the users.

9. A method comprising:
setting a desired usage time;
measuring a remaining coulomb;
calculating a remaining coulomb consumption rate;
calculating a mandatory coulomb consumption rate of a function module with the highest priority level;
determining whether the mandatory coulomb consumption rate is larger than the remaining coulomb consumption rate;
determining whether the mandatory coulomb consumption rate is equal to the remaining coulomb consumption rate; and
powering down function modules except for the function module with the highest priority level.

10. The method according to claim 9, further comprising:
calculating a longest operable time if the mandatory coulomb consumption rate is larger than the remaining coulomb consumption rate;
indicating the longest operable time.

11. The method according to claim 9, further comprising:
calculating a total coulomb consumption rate of all the function modules;
determining whether the total coulomb consumption rate is larger than the remaining coulomb consumption rate;
ending the method if the total coulomb consumption rate is not larger than the remaining coulomb consumption rate.

12. The method according to claim 11, further comprising:
powering down a function module with a comparative lower priority level;
calculating a new total coulomb consumption rate of the rest function modules except for the powered down function module;
going to block “determining whether the total coulomb consumption rate is larger than the remaining coulomb consumption rate.”
